(19) United States
(12) Patent Application Publication
(10) Pub. No.: US 2024/0319767 A1
(43) Pub. Date: Sep. 26, 2024

(54) Split-screen display device for notebook computer screen

(71) Applicant: Shenzhen E-Tech Digital Technology Co., Ltd., Shenzhen City (CN)

(72) Inventor: Yang Gu, Shenzhen City (CN)

(21) Appl. No.: 18/680,471

(22) Filed: May 31, 2024

Related U.S. Application Data
(63) Continuation of application No. 17/023,411, filed on Sep. 17, 2020.

(51) Int. Cl. G06F 1/16

(52) U.S. Cl. CPC G06F 1/1647; G06F 1/1681

(57) ABSTRACT

The present disclosure discloses a split-screen display device for a notebook computer screen, which comprises a left support plate and a right support plate, wherein a left slide arm is formed at an edge of the left support plate, a right slide arm is formed at an edge of the right support plate, the right slide arm and the left slide arm are parallel up and down, the left slide arm is inserted into the right support plate and the two are in a slide fit, the right slide arm is inserted into the left support plate and the two are in a slide fit, clamping mechanisms for clamping a notebook computer screen are respectively provided at an upper left corner of the left support plate and an upper right corner of the right support plate, a left display screen is provided at a left edge of the left support plate and the two are in a hinge fit, a right display screen is provided at a right edge of the right support plate and the two are in a hinge fit, and a support mechanism capable of being flipped outward a predetermined angle is provided at a back side of the left support plate or the right support plate. The present disclosure achieves a split-screen display and can adapt to notebook computer screens of various sizes. Moreover, the present disclosure is compact in volume and has both folding and supporting capabilities, so that user needs and market requirements are satisfied well.

### CROSS REFERENCE TO RELATED APPLICATION

This application is a continuation of U.S. application Ser. No. 17/023,411, entitled “Split-screen display device for notebook computer screen,” filed Sep. 17, 2020, and the entire contents of which are incorporated herein by reference.

### TECHNICAL FIELD

The present disclosure relates to a split-screen display, and in particular to a split-screen display device for a notebook computer screen.

### BACKGROUND

In the prior art, in a situation where a multi-screen display is required during work, the extension may be achieved by using a method of externally connecting a notebook computer to a display. However, this method of extending an independent display is not only cumbersome, but also inconvenient for users' operation and watching. It can be learned that how to achieve a miniaturized split-screen display and how to match notebook computer screens of various sizes have become technical problems to be solved urgently in the prior art.

### SUMMARY

Technical problems to be solved by the present disclosure is that, in view of the shortcomings of the prior art, it provides a split-screen display device for a notebook computer screen that can achieve a split-screen display, can adapt to notebook computer screens of various sizes, is compact in volume, and has both folding and supporting capabilities.

In order to solve the above technical problems, the present disclosure uses the technical solutions as follows:

A split-screen display device for a notebook computer screen comprises a left support plate and a right support plate, wherein a left slide arm is formed at an edge of the left support plate, a right slide arm is formed at an edge of the right support plate, the right slide arm and the left slide arm are parallel up and down, the left slide arm is inserted into the right support plate and the two are in a slide fit, the right slide arm is inserted into the left support plate and the two are in a slide fit, clamping mechanisms for clamping a notebook computer screen are respectively provided at an upper left corner of the left support plate and an upper right corner of the right support plate, a left display screen is provided at a left edge of the left support plate and the two are in a hinge fit, a right display screen is provided at a right edge of the right support plate and the two are in a hinge fit, and a support mechanism capable of being flipped outward a predetermined angle is provided at a back side of the left support plate or the right support plate.

Preferably, a gear is provided in the right support plate, a rack part is formed at a side of the left slide arm, and the rack part and the gear mesh with each other.

Preferably, the left support plate comprises a left bottom plate and a left face plate, and the left bottom plate and the left face plate are assembled opposite one another and fixedly connected.

Preferably, the right support plate comprises a right bottom plate and a right face plate, and the right bottom plate and the right face plate are assembled opposite one another and fixedly connected.

Preferably, a circular support is formed at a left edge of the right bottom plate, and the gear is provided in the circular support and the two are in a rotating fit.

Preferably, a circular face cover is formed on the right face plate, the circular face cover covers the gear, and the circular face cover and the circular support are engaged mutually.

Preferably, a semicircular notch is defined at a right edge of the left support plate, and the semicircular notch is provided opposite the circular support; and the left half of the circular support is accommodated in the semicircular notch when the left support plate and the right support plate are assembled opposite one another.

Preferably, a side shell is formed at each of an edge of the left support plate and an edge of the right support plate, the clamping mechanism comprises an inverted U-shaped buckle piece, a first support arm of the inverted U-shaped buckle piece is inserted into the side shell, the first support arm is capable of sliding back and forth relative to the side shell, a second support arm of the inverted U-shaped buckle piece extends toward a front side of the side shell, a clamping opening for clamping a notebook computer screen is formed between the second support arm and the side shell, a clamping spring is clamped between a front side of the first support arm and the side shell, and the inverted U-shaped buckle piece is driven to move backward by means of an elastic force exerted by the clamping spring, to clamp the notebook computer screen into the clamping opening.

Preferably, front step parts protruding forward are respectively formed at upper and lower ends of the right support plate, the right display screen is clamped between the upper and lower front step parts, and the right display screen is rotationally connected to both of the upper and lower front step parts; and rear step parts protruding backward are respectively formed at upper and lower ends of the left support plate, the left display screen is clamped between the upper and lower rear step parts, and the left display screen is rotationally connected to both of the upper and lower rear step parts; the right display screen is enabled to flip toward a front side of the left support plate and the right support plate by means of fits between the right display screen and the upper and lower front step parts; and the left display screen is enabled to flip toward a back side of the left support plate and the right support plate by means of fits between the left display screen and the upper and lower rear step parts.

Preferably, a clamping groove is defined at the back side of the left support plate or the right support plate, the support mechanism comprises a square-tube bracing arm, the square-tube bracing arm is provided in the clamping groove, the square-tube bracing arm is capable of being flipped a predetermined angle relative to the clamping groove, a telescopic arm penetrates into the square-tube bracing arm, the telescopic arm extends from a lower end of the square-tube bracing arm, the telescopic arm and the square-tube bracing arm are in a slide fit, a tightening screw penetrates into a side part of the square-tube bracing arm, the tightening screw and the square-tube bracing arm are in a thread fit, an end of the tightening screw faces the telescopic arm, and the telescopic arm is fixed in the square-tube bracing arm by means of a tight fit between the tightening screw and the telescopic arm.

In the split-screen display device for a notebook computer screen that is disclosed in the present disclosure, the left support plate and the right support plate can be attached to a back side of the notebook computer screen, and clamping mechanisms are used to fix the notebook computer screen to the left support plate and the right support plate mutually, so as to better combine the split-screen display device with the notebook computer screen for use and to achieve the split-screen display in combination with the foldable left display screen and right display screen. When the split-screen display device needs to be used independently, the support mechanism can also be used to support the split-screen display device in an obliquely standing state, so as to satisfy various application requirements. Based on the above characteristics, it can be learned that compared with the prior art, the present disclosure achieves the split-screen display and can adapt to notebook computer screens of various sizes. Moreover, the present disclosure is compact in volume and has both folding and supporting capabilities, so that user needs and market requirements are satisfied well.

### BRIEF DESCRIPTION OF THE DRAWINGS

FIG. 1 is a first space diagram of a split-screen display device in an unfolded state;

FIG. 2 is a second space diagram of a split-screen display device in an unfolded state;

FIG. 3 is a diagram of internal structures of a left support plate and a right support plate;

FIG. 4 is a first structural diagram of a clamping mechanism;

FIG. 5 is a second structural diagram of a clamping mechanism;

FIG. 6 is a first partial exploded view of a clamping mechanism;

FIG. 7 is a second partial exploded view of a clamping mechanism;

FIG. 8 is a first structural diagram of a display screen flipping mechanism;

FIG. 9 is a second structural diagram of a display screen flipping mechanism;

FIG. 10 is a first space diagram of a split-screen display device in a folded state;

FIG. 11 is a second space diagram of a split-screen display device in a folded state;

FIG. 12 is a structural diagram of a support mechanism; and

FIG. 13 is an exploded view of a support mechanism.

### DETAILED DESCRIPTION OF THE EMBODIMENTS

The present disclosure will be described in more detail below in conjunction with the accompanying drawings and embodiments.

### Embodiment I

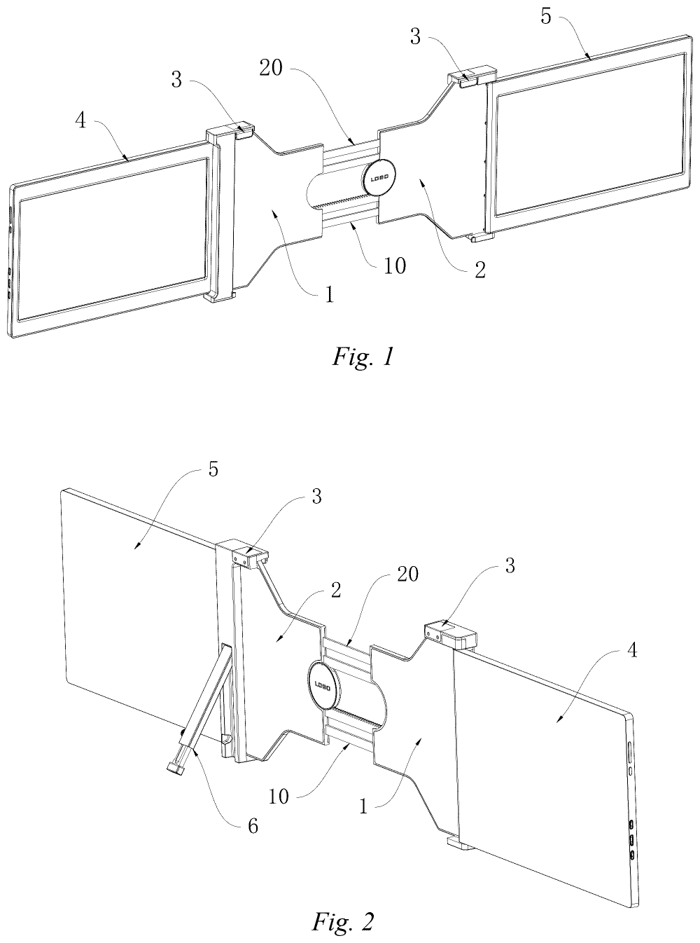

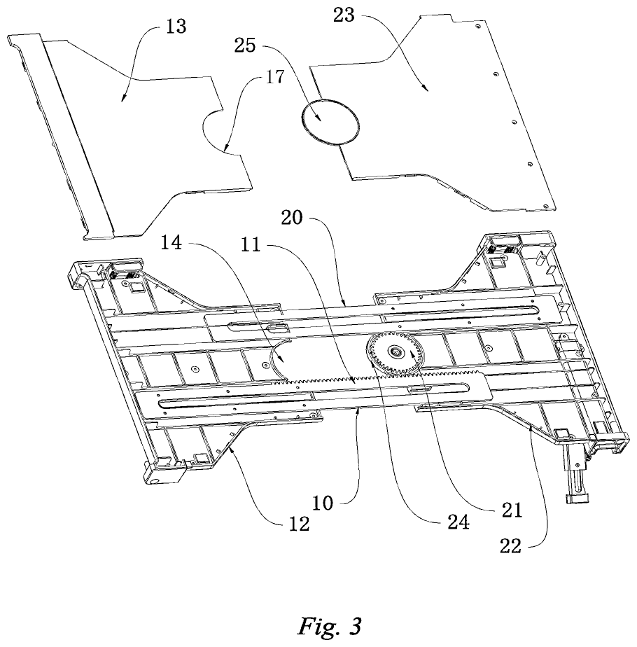

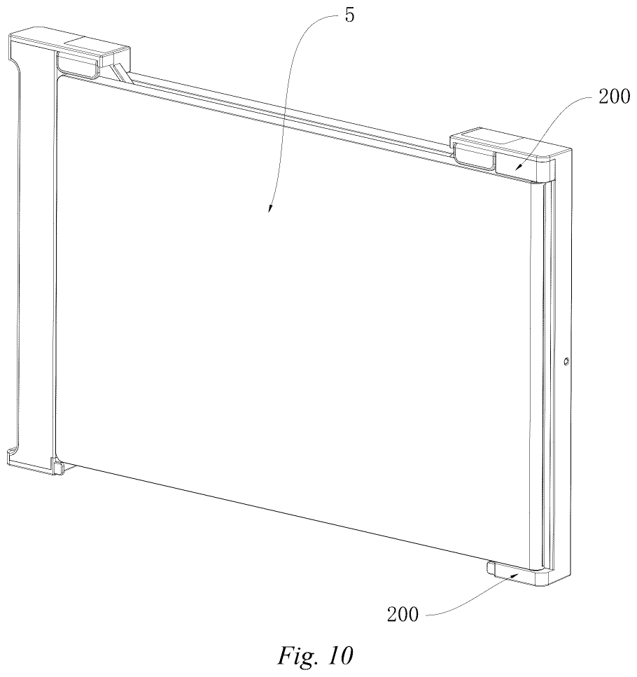

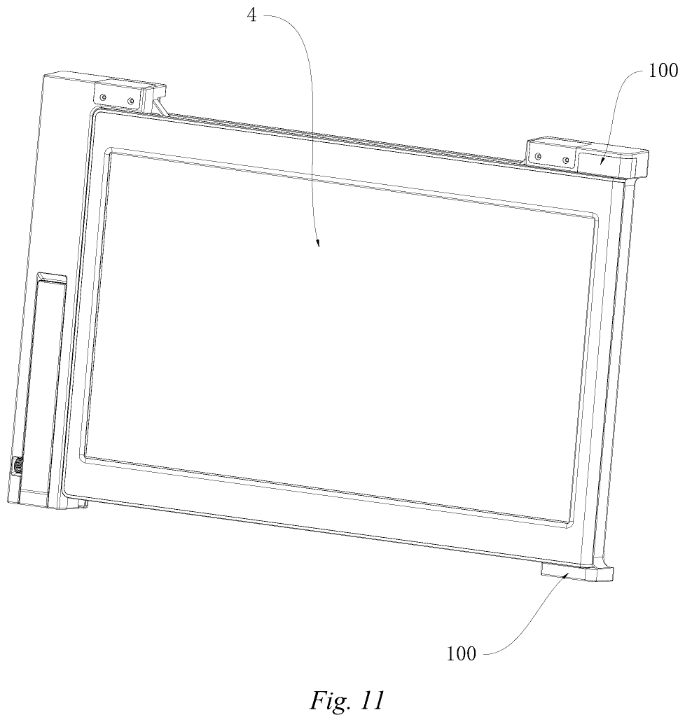

This embodiment proposes a split-screen display device for a notebook computer screen. As shown in FIG. 1, FIG. 2, FIG. 3, FIG. 10, and FIG. 11, the split-screen display device comprises a left support plate 1 and a right support plate 2, wherein a left slide arm 10 is formed at an edge of the left support plate 1, a right slide arm 20 is formed at an edge of the right support plate 2, the right slide arm 20 and the left slide arm 10 are parallel up and down, the left slide arm 10 is inserted into the right support plate 2 and the two are in a slide fit, the right slide arm 20 is inserted into the left support plate 1 and the two are in a slide fit, clamping mechanisms 3 for clamping a notebook computer screen are respectively provided at an upper left corner of the left support plate 1 and an upper right corner of the right support plate 2, a left display screen 4 is provided at a left edge of the left support plate 1 and the two are in a hinge fit, a right display screen 5 is provided at a right edge of the right support plate 2 and the two are in a hinge fit, and a support mechanism 6 capable of being flipped outward a predetermined angle is provided at a back side of the left support plate 1 or the right support plate 2.

In the above device, the left support plate 1 and the right support plate 2 can be attached to a back side of the notebook computer screen, and clamping mechanisms 3 are used to fix the notebook computer screen to the left support plate 1 and the right support plate 2 mutually, so as to better combine the split-screen display device with the notebook computer screen for use and to achieve the split-screen display in combination with the foldable left display screen 4 and right display screen 5. When the split-screen display device needs to be used independently, the support mechanism 6 can also be used to support the split-screen display device in an obliquely standing state, so as to satisfy various application requirements. Based on the above characteristics, it can be learned that compared with the prior art, the present disclosure achieves the split-screen display and can adapt to notebook computer screens of various sizes. Moreover, the present disclosure is compact in volume and has both folding and supporting capabilities, so that user needs and market requirements are satisfied well.

In a preferred manner, a gear 21 is provided in the right support plate 2, a rack part 11 is formed at a side of the left slide arm 10, and the rack part 11 and the gear 21 mesh with each other.

Under the action of a fit between the gear 21 and the rack part 11, the left slide arm 10 can not only slide relative to the right support plate 2, but also can be linked with the gear 21. Because there is a certain damping between the gear 21 and the rack part 11, the relative translation movement between the left support plate 1 and the right support plate 2 is more stable; and there is a certain positioning function, which can effectively prevent the left support plate 1 and the right support plate 2 from opening automatically during use. This greatly improves the stability and reliability of the split-screen display device.

Further, the left support plate 1 comprises a left bottom plate 12 and a left face plate 13, and the left bottom plate 12 and the left face plate 13 are assembled opposite one another and fixedly connected.

Correspondingly, the right support plate 2 comprises a right bottom plate 22 and a right face plate 23, and the right bottom plate 22 and the right face plate 23 are assembled opposite one another and fixedly connected.

In order to better accommodate the gear 21, in this embodiment, a circular support 24 is formed at a left edge of the right bottom plate 22, and the gear 21 is provided in the circular support 24 and the two are in a rotating fit.

Correspondingly, a circular face cover 25 is formed on the right face plate 23, the circular face cover 25 covers the gear 21, and the circular face cover 25 and the circular support 24 are engaged mutually.

In order to better match each other after being assembled, in this embodiment, a semicircular notch 14 is defined at a right edge of the left support plate 1, and the semicircular notch 14 is provided opposite the circular support 24; and the left half of the circular support 24 is accommodated in the semicircular notch 14 when the left support plate 1 and the right support plate 2 are assembled opposite one another.

In one embodiment, a second semicircular notch 17 is defined at a right edge of the left face plate 13, and the second semicircular notch 17 is aligned with the first semicircular notch 14.

In a preferred manner, a side shell 30 is formed at each of an edge of the left support plate 1 and an edge of the right support plate 2, the clamping mechanism 3 comprises an inverted U-shaped buckle piece 31, a first support arm 310 of the inverted U-shaped buckle piece 31 is inserted into the side shell 30, the first support arm 310 is capable of sliding back and forth relative to the side shell 30, a second support arm 311 of the inverted U-shaped buckle piece 31 extends toward a front side of the side shell 30, a clamping opening 32 for clamping a notebook computer screen is formed between the second support arm 311 and the side shell 30, a clamping spring 33 is clamped between a front side of the first support arm 310 and the side shell 30, and the inverted U-shaped buckle piece 31 is driven to move backward by means of an elastic force exerted by the clamping spring 33, to clamp the notebook computer screen into the clamping opening 32.

In this embodiment, front step parts 200 protruding forward are respectively formed at upper and lower ends of the right support plate 2, and the right display screen 5 is clamped between the upper and lower front step parts 200, and the right display screen 5 is rotationally connected to both of the upper and lower front step parts 200; and rear step parts 100 protruding backward are respectively formed at upper and lower ends of the left support plate 1, the left display screen 4 is clamped between the upper and lower rear step parts 100, and the left display screen 4 is rotationally connected to both of the upper and lower rear step parts 100;
the right display screen 5 is enabled to flip toward a front side of the left support plate 1 and the right support plate 2 by means of fits between the right display screen 5 and the upper and lower front step parts 200; and
the left display screen 4 is enabled to flip toward a back side of the left support plate 1 and the right support plate 2 by means of fits between the left display screen 4 and the upper and lower rear step parts 100.

In this embodiment, a clamping groove 60 is defined at the back side of the left support plate 1 or the right support plate 2, the support mechanism 6 comprises a square-tube bracing arm 61, the square-tube bracing arm 61 is provided in the clamping groove 60, the square-tube bracing arm 61 is capable of being flipped a predetermined angle relative to the clamping groove 60, a telescopic arm 62 penetrates into the square-tube bracing arm 61, the telescopic arm 62 extends from a lower end of the square-tube bracing arm 61, the telescopic arm 62 and the square-tube bracing arm 61 are in a slide fit, a tightening screw 63 penetrates into a side part of the square-tube bracing arm 61, the tightening screw 63 and the square-tube bracing arm 61 are in a thread fit, an end of the tightening screw 63 faces the telescopic arm 62, and the telescopic arm 62 is fixed in the square-tube bracing arm 61 by means of a tight fit between the tightening screw 63 and the telescopic arm 62.

### Embodiment II

In practical applications, when a split-screen display device needs to be used with a notebook computer, it is best to hang the split-screen display device on a notebook computer screen, but how to combine the split-screen display device with the notebook computer screen well and how to prevent the split-screen display device from falling during use are technical problems to be solved urgently in the prior art.

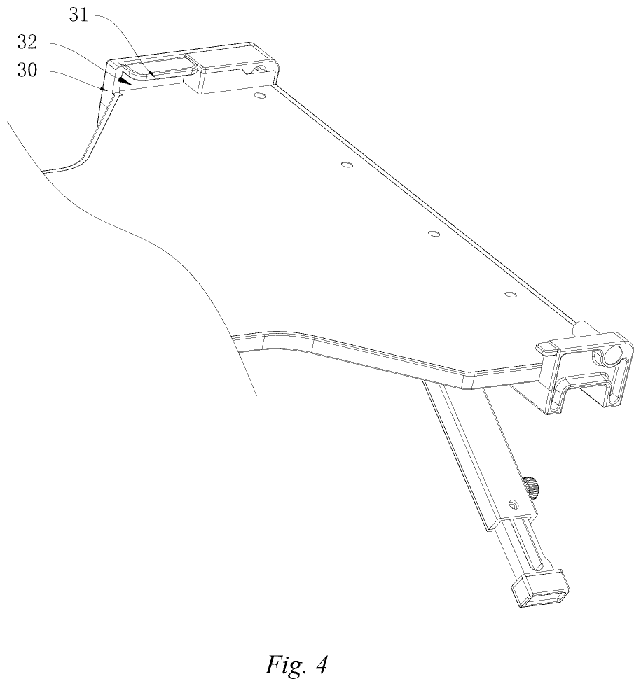

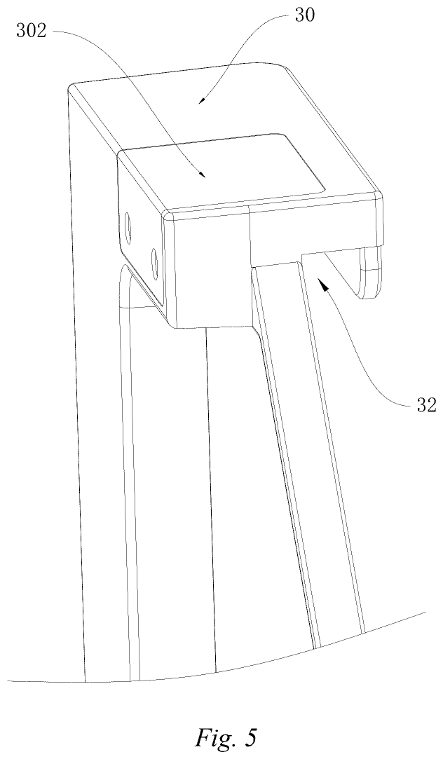

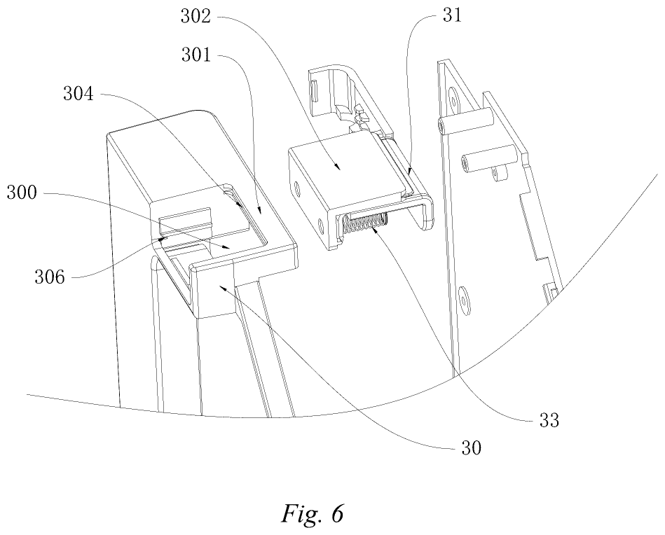

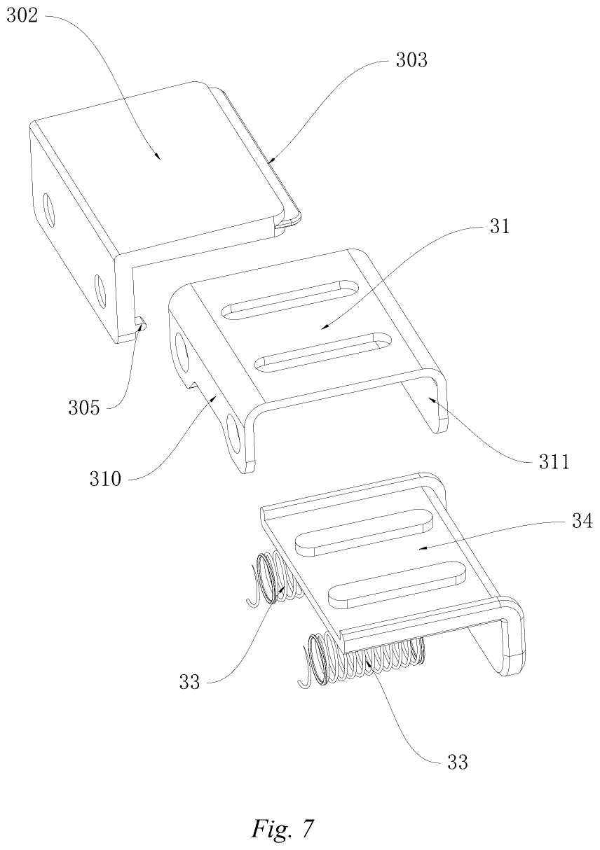

In this regard, this embodiment proposes a notebook computer screen clamping mechanism for the split-screen display device. As shown in FIG. 1, FIG. 2, and FIGS. 4 to 7, the clamping mechanisms 3 are provided on a left support plate 1 and a right support plate 2 of the split-screen display device, a side shell 30 is formed at each of an edge of the left support plate 1 and an edge of the right support plate 2, the clamping mechanism 3 comprises an inverted U-shaped buckle piece 31, a first support arm 310 of the inverted U-shaped buckle piece 31 is inserted into the side shell 30, the first support arm 310 is capable of sliding back and forth relative to the side shell 30, a second support arm 311 of the inverted U-shaped buckle piece 31 extends toward a front side of the side shell 30, a clamping opening 32 for clamping a notebook computer screen is formed between the second support arm 311 and the side shell 30, a clamping spring 33 is clamped between a front side of the first support arm 310 and the side shell 30, and the inverted U-shaped buckle piece 31 is driven to move backward by means of an elastic force exerted by the clamping spring 33, to clamp the notebook computer screen into the clamping opening 32.

In the above mechanism, the inverted U-shaped buckle pieces 31 are respectively provided at the edge of the left support plate 1 and the edge of the right support plate 2, and the split-screen display device can be buckled on an upper edge of the notebook computer screen by using the inverted U-shaped buckle pieces 31. On this basis, the present disclosure enables the first support arm 310 of the inverted U-shaped buckle piece 31 to slide back and forth relative to the side shell 30, and the notebook computer screen may be elastically clamped into the clamping opening 32 under the action of the elastic force exerted by the clamping spring 33, so that the left support plate 1 and the right support plate 2 can not only be stably attached to a back side of the notebook computer screen, but also can be more reliably elastically clamped and fit in with the notebook computer screen. Compared with the prior art, the present disclosure can make the split-screen display device and the notebook computer screen combined well, so that the split-screen display device can be effectively prevented from falling during use, and the use safety and reliability are greatly improved.

In order to better accommodate the inverted U-shaped buckle piece 31, in this embodiment, a socket 300 is defined on the side shell 30, and the inverted U-shaped buckle piece 31 is provided in the socket 300.

In order to shield and hide the inverted U-shaped buckle piece 31, in this embodiment, a blocking edge 301 is formed at a front side of the socket 300, an L-shaped baffle 302 is provided above the inverted U-shaped buckle piece 31, a tongue 303 is formed at a front end of the L-shaped baffle 302, a tongue groove 304 is defined on the blocking edge 301, the tongue 303 is inserted into the tongue groove 304 and the two are in a snug fit, a protrusion 305 is formed at an inner side of the L-shaped baffle 302, a fixing groove 306 is defined on an inner wall of the socket 300, and the protrusion 305 is inserted into the fixing groove 306 and the two are in a snug fit.

In order to avoid damage to the notebook computer screen, in this embodiment, a soft foot pad 34 is fixed on an inner wall of the inverted U-shaped buckle piece 31.

In a preferred manner, two clamping springs 33 are clamped between a front side of the first support arm 310 and the side shell 30.

### Embodiment III

In practical applications, for some electronic products with foldable screens, it is only necessary to provide a hinge shaft between a screen and a body; but for products with foldable screens on both sides, one screen is generally folded on a body, and the other screen is folded on the outside of the screen. This folding method causes a hinge part at one side of the body to be thick and heavy, and a hinge part at the other side of the body to be light and thin. The weight distribution at the two sides of the body is uneven, so it is difficult to achieve stable hanging or placement during use. Consequently, the stability and reliability are insufficient.

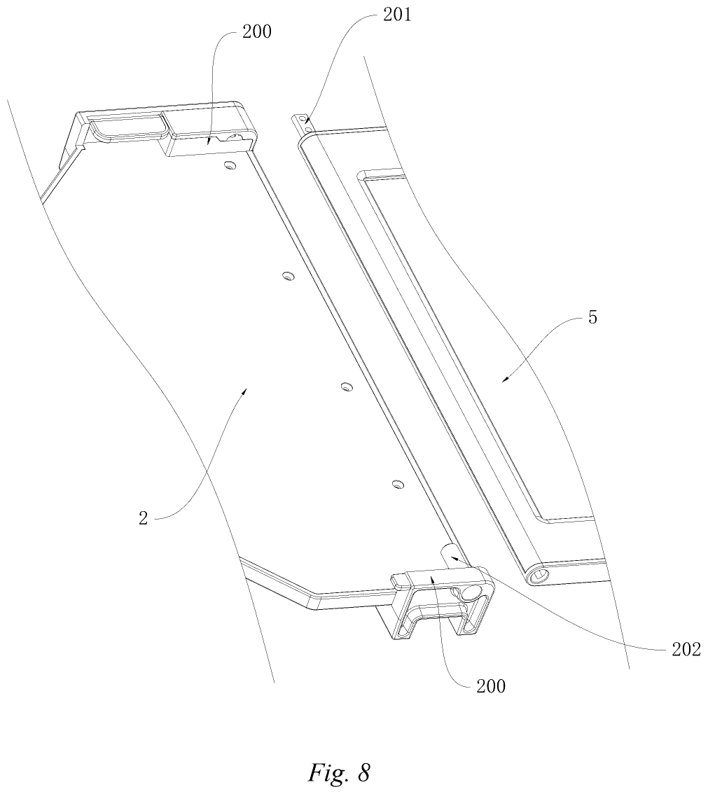

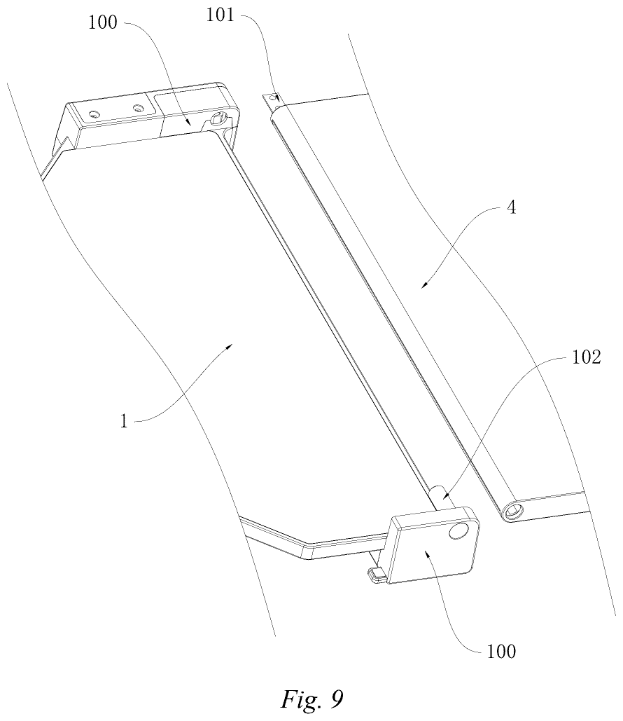

In this regard, this embodiment proposes a display screen flipping mechanism for a split-screen display device. As shown in FIG. 1, FIG. 2, and FIGS. 8 to 11, the split-screen display device comprises a left support plate 1 and a right support plate 2, a right display screen 5 is provided at a right edge of the right support plate 2, front step parts 200 protruding forward are respectively formed at upper and lower ends of the right support plate 2, the right display screen 5 is clamped between the upper and lower front step parts 200, and the right display screen 5 is rotationally connected to both of the upper and lower front step parts 200; and a left display screen 4 is provided at a left edge of the left support plate 1, rear step parts 100 protruding backward are respectively formed at upper and lower ends of the left support plate 1, the left display screen 4 is clamped between the upper and lower rear step parts 100, and the left display screen 4 is rotationally connected to both of the upper and lower rear step parts 100;
the right display screen 5 is enabled to flip toward a front side of the left support plate 1 and the right support plate 2 by means of fits between the right display screen 5 and the upper and lower front step parts 200; and
the left display screen 4 is enabled to flip toward a back side of the left support plate 1 and the right support plate 2 by means of fits between the left display screen 4 and the upper and lower rear step parts 100.

In the above mechanism, the front step parts 200 are respectively provided at the upper and lower ends of the right support plate 2, and the rear step parts 100 are respectively provided at the upper and lower ends of the left support plate 1. Because the front step parts 200 protrude forward, the right display screen 5 can be flipped and folded to the front side. Because the rear step pats 100 protrude backward, the left display screen 4 can be flipped and folded to the back side. Based on the above principle, it can be learned that the right display screen 5 and the left display screen 4 in this embodiment are flipped to the front side and the back side respectively. Compared with the method of flipping to the same side in the prior art, the weight on both sides of the left and right support plates of the present disclosure is more balanced. When the split-screen display device is hung on the notebook computer screen, a matching relationship between the device and the notebook computer screen is more stable and reliable, so that user needs and market requirements are satisfied well.

In this embodiment, the front step part 200 at an upper end of the right support plate 2 and the right display screen 5 are connected by a right rotating shaft 201.

In order to provide damping for the right display screen 5 to enable the right display screen 5 to be positioned at a corresponding flip position, in this embodiment, the front step part 200 at a lower end of the right support plate 2 and the right display screen 5 are connected by a right damping shaft 202.

Similarly, the rear step part 100 at an upper end of the left support plate 1 and the left display screen 4 are connected by a left rotating shaft 101.

In order to provide damping for the left display screen 4 to enable the left display screen 4 to be positioned at a corresponding flip position, in this embodiment, the rear step part 100 at a lower end of the left support plate 1 and the left display screen 4 are connected by a left damping shaft 102.

### Embodiment IV

In practical applications, some small split-screen display devices need to be hung on a notebook computer screen to better match the notebook computer screen for use. However, when the split-screen display device is used independently, the split-screen display device needs to lean on a certain place to facilitate user watching because the split-screen display device is difficult to be placed upright or obliquely. It can be learned that the existing split-screen display device is difficult to satisfy user requirements due to the lack of a supporting function.

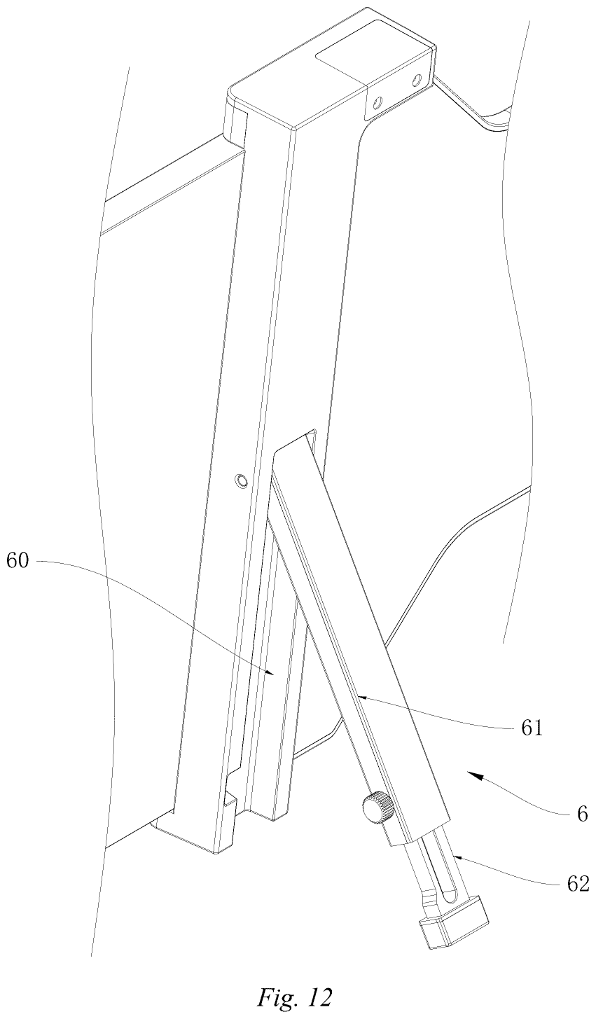

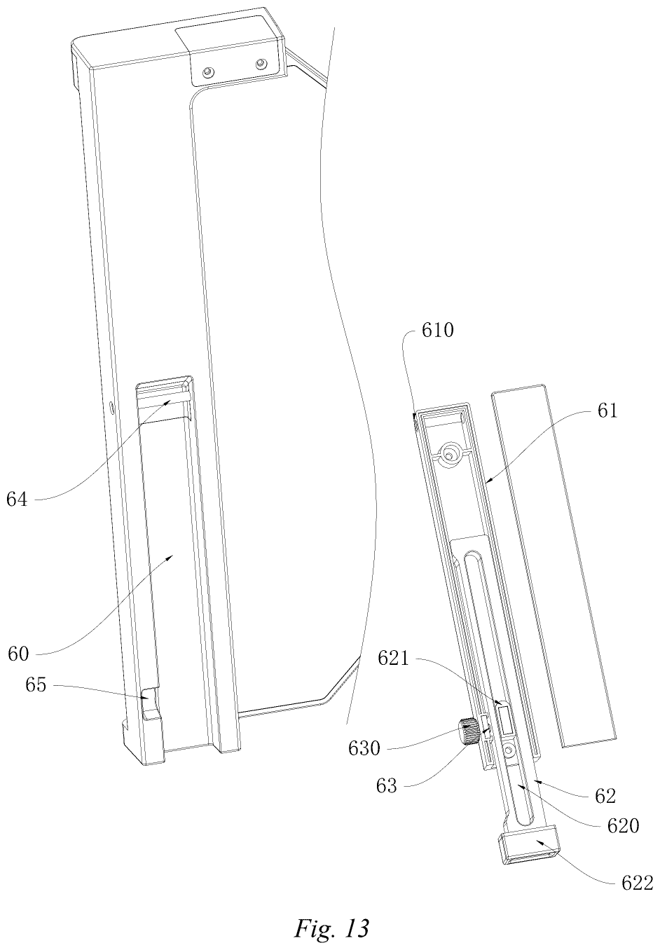

In this regard, this embodiment proposes a support mechanism for a split-screen display device. As shown in FIG. 1, FIG. 2, FIG. 12, and FIG. 13, the support mechanism 6 is installed on the left support plate 1 or the right support plate 2 of the split-screen display device, a clamping groove 60 is defined at the back side of the left support plate 1 or the right support plate 2, the support mechanism 6 comprises a square-tube bracing arm 61, the square-tube bracing arm 61 is provided in the clamping groove 60, the square-tube bracing arm 61 is capable of being flipped a predetermined angle relative to the clamping groove 60, a telescopic arm 62 penetrates into the square-tube bracing arm 61, the telescopic arm 62 extends from a lower end of the square-tube bracing arm 61, the telescopic arm 62 and the square-tube bracing arm 61 are in a slide fit, a tightening screw 63 penetrates into a side part of the square-tube bracing arm 61, the tightening screw 63 and the square-tube bracing arm 61 are in a thread fit, an end of the tightening screw 63 faces the telescopic arm 62, and the telescopic arm 62 is fixed in the square-tube bracing arm 61 by means of a tight fit between the tightening screw 63 and the telescopic arm 62.

In the above mechanism, the clamping groove 60 is provided at the back side of the left support plate 1 or the right support plate 2, and the square-tube bracing arm 61 is capable of being flipped a predetermined angle relative to the clamping groove 60. When the split-screen display device needs to be used independently, the square-tube bracing arm 61 can be flipped outward, then the telescopic arm 62 can be extended by a corresponding length, and then the tightening screw 63 can be used to lock the telescopic arm 62 in the square-tube bracing arm 61. Based on the above structural relationship, the telescopic arm 62 and the square-tube bracing arm 61 can be used to support the left support plate 1 or the right support plate 2, so that the split-screen display device can stand upright or be tilted at a certain angle to satisfy an application requirement for independent use. When the split-screen display device needs to be used in combination with the notebook computer screen, it is only necessary to unscrew the tightening screw 63, retract the telescopic arm 62 into the square-tube bracing arm 61, and then flip the square-tube bracing arm 61 back into the clamping groove 60 to complete folding. Compared with the prior art, the support mechanism in the present disclosure has simple retracting and unfolding operations and is easy to use, so that various use requirements can be satisfied.

In this embodiment, a transverse shaft 64 is fixed in the clamping groove 60. The transverse shaft 64 passes through an upper end part of the square-tube bracing arm 61 and the two are in a rotating fit. A round corner part 610 is formed in a corner at an upper end of the square-tube bracing arm 61, the round corner part 610 abuts against inner walls of the clamping groove 60, and the round corner part 610 and the inner walls of the clamping groove 60 are in a slide fit. Based on the above structural relationship, the square-tube bracing arm 61 can be positioned at a corresponding angle after being flipped outward, thereby limiting a flipping range of the square-tube bracing arm 61.

In order to limit a telescopic stroke of the telescopic arm 62, in this embodiment, an elongated rabbet 620 is defined on the telescopic arm 62, the elongated rabbet 620 extends along a length direction of the telescopic arm 62, a limit block 621 is fixed in the square-tube bracing arm 61, and the limit block 621 is clamped in the elongated rabbet 620 and the two are connected by sliding.

In order to facilitate screwing of the tightening screw 63, in this embodiment, a screw nut 630 is formed at a part of the tightening screw 63 outside the square-tube bracing arm 61, an accommodating groove 64 is defined at an edge of the clamping groove 60, and the screw nut 630 is accommodated in the accommodating groove 64 when the square-tube bracing arm 61 is flipped into the clamping groove 60.

In a preferred manner, a soft rubber pad 622 is fixed at a lower end of the telescopic arm 62.

The above embodiments are merely preferred embodiments of the present disclosure but not intended to limit the present disclosure, and any modifications, equivalent replacements, improvements, etc. made within the technical scope of the present disclosure should be included within the scope of protection of the present disclosure.

What is claimed is:

1. A split-screen display device for a notebook computer screen, comprising:
a left support plate (1) comprising a left bottom plate (12) and a left face plate (13) wherein the left bottom plate (12) and the left face plate (13) are assembled opposite one another and fixedly connected; a first semicircular notch (14) is defined at a right edge of the left bottom plate (12), a second semicircular notch (17) is defined at a right edge of the left face plate (13); and the second semicircular notch (17) is aligned with the first semicircular notch (14);
a right support plate (2) comprising a right bottom plate (22) and a right face plate (23), wherein the right bottom plate (22) and the right face plate (23) are assembled opposite one another and fixedly connected; a circular support (24) is formed at a left edge of the right bottom plate (22); a circular face cover (25) is formed on the right face plate (23); a gear (21) is provided in the right support plate (2); the circular face cover (25) covers the gear (21); the circular face cover (25) and the circular support (24) are aligned and engaged mutually; the first semicircular notch (14) is provided opposite the circular support (24); the second semicircular notch (17) is provided opposite the circular face cover (25), the left half of the circular support (24) is accommodated in the first semicircular notch (14), and the second semicircular notch (17) when the left support plate (1) and the right support plate (2) are assembled opposite one another; and
the gear (21) is provided in the circular support (24) and the two are in a rotating fit;
wherein a left slide arm (10) is formed at an edge of the left support plate (1);
a right slide arm (20) is formed at an edge of the right support plate (2);
the right slide arm (20) and the left slide arm (10) are parallel up and down;
the left slide arm (10) is inserted into the right support plate (2) and the two are in a slide fit, the right slide arm (20) is inserted into the left support plate (1) and the two are in a slide fit, wherein the left slide arm (10) is disposed between the left bottom plate (12) and the left face plate (13) and the right slide arm (20) is disposed between the right bottom plate (22) and the right face plate (23);
clamping mechanisms (3) for clamping a notebook computer screen are respectively provided at an upper left corner of the left support plate (1) and an upper right corner of the right support plate (2);
a left display screen (4) is provided at a left edge of the left support plate (1) and the two are in a hinge fit;
a right display screen (5) is provided at a right edge of the right support plate (2) and the two are in a hinge fit;
a support mechanism (6) capable of being flipped outward a predetermined angle is provided at a back side of the left support plate (1) or the right support plate (2);
a gear (21) is provided on the right support plate (2);
a rack part (11) is integrally formed at a side of the left slide arm (10), and the rack part (11) and the gear (21) mesh with each other; and
when the rack part (11) slides relative to the right support plate (2), the gear (21) is driven to rotate by the rack part (11); and the left support plate (1) and the right support plate (2) are prevented from opening automatically during use through an engagement of the gear (21) and the rack part (11).

2. The split-screen display device for a notebook computer screen of claim 1, wherein a circular face cover (25) is formed on the right face plate (23), the circular face cover (25) covers the gear (21), and the circular face cover (25) and the circular support (24) are engaged mutually.

3. The split-screen display device for a notebook computer screen of claim 2, wherein a semicircular notch (14) is defined at a right edge of the left support plate (1), and the semicircular notch (14) is provided opposite the circular support (24); and the left half of the circular support (24) is accommodated in the semicircular notch (14) when the left support plate (1) and the right support plate (2) are assembled opposite one another.

4. The split-screen display device for a notebook computer screen of claim 1, wherein a side shell (30) is formed at each of an edge of the left support plate (1) and an edge of the right support plate (2), the clamping mechanism (3) comprises an inverted U-shaped buckle piece (31), a first support arm (310) of the inverted U-shaped buckle piece (31) is inserted into the side shell (30), the first support arm (310) is capable of sliding back and forth relative to the side shell (30), a second support arm (311) of the inverted U-shaped buckle piece (31) extends toward a front side of the side shell (30), a clamping opening (32) for clamping a notebook computer screen is formed between the second support arm (311) and the side shell (30), a clamping spring (33) is clamped between a front side of the first support arm (310) and the side shell (30), and the inverted U-shaped buckle piece (31) is driven to move backward by means of an elastic force exerted by the clamping spring (33), to clamp the notebook computer screen into the clamping opening (32).

5. The split-screen display device for a notebook computer screen of claim 1, wherein front step parts (200) protruding forward are respectively formed at upper and lower ends of the right support plate (2), the right display screen (5) is clamped between the upper and lower front step parts (200), and the right display screen (5) is rotationally connected to both of the upper and lower front step parts (200); and rear step parts (100) protruding backward are respectively formed at upper and lower ends of the left support plate (1), the left display screen (4) is clamped between the upper and lower rear step parts (100), and the left display screen (4) is rotationally connected to both of the upper and lower rear step parts (100);
the right display screen (5) is enabled to be flipped toward a front side of the left support plate (1) and the right support plate (2) by means of fits between the right display screen (5) and the upper and lower front step parts (200); and
the left display screen (4) is enabled to be flipped toward a back side of the left support plate (1) and the right support plate (2) by means of fits between the left display screen (4) and the upper and lower rear step parts (100).

6. The split-screen display device for a notebook computer screen of claim 1, wherein a clamping groove (60) is defined at the back side of the left support plate (1) or the right support plate (2), the support mechanism (6) comprises a square-tube bracing arm (61), the square-tube bracing arm (61) is provided in the clamping groove (60), the square-tube bracing arm (61) is capable of being flipped a predetermined angle relative to the clamping groove (60), a telescopic arm (62) penetrates into the square-tube bracing arm (61), the telescopic arm (62) extends from a lower end of the square-tube bracing arm (61), the telescopic arm (62) and the square-tube bracing arm (61) are in a slide fit, a tightening screw (63) penetrates into a side part of the square-tube bracing arm (61), the tightening screw (63) and the square-tube bracing arm (61) are in a thread fit, an end of the tightening screw (63) faces the telescopic arm (62), and the telescopic arm (62) is fixed in the square-tube bracing arm (61) by means of a tight fit between the tightening screw (63) and the telescopic arm (62).
